(19) United States
(12) Patent Application Publication
(10) Pub. No.: US 2020/0109269 A1
(43) Pub. Date: Apr. 9, 2020

(54) METHOD FOR PRODUCING RUBBER WET MASTERBATCH

(71) Applicant: Toyo Tire Corporation, Itami-shi (JP)

(72) Inventor: Kazuya Hirabayashi, Itami-shi (JP)

(73) Assignee: Toyo Tire Corporation, Itami-shi (JP)

(21) Appl. No.: 16/573,462

(22) Filed: Sep. 17, 2019

(30) Foreign Application Priority Data
Oct. 3, 2018 (JP) 2018-188054

(51) Int. Cl. C08L 7/02; C08J 3/22; B60C 1/00

(52) U.S. Cl. CPC C08L 7/02; C08J 3/226; B60C 1/00; B60C 2001/0058; C08L 2201/52; C08L 2310/00; C08L 2205/03; C08L 2205/16

(57) ABSTRACT

A method for producing a rubber wet masterbatch comprises a step (i) of dispersing an inorganic filler into a dispersing solvent in the presence of a cellulose fiber to produce a slurry solution, a step (ii) of mixing the slurry solution and a rubber latex solution with each other to produce a slurry-containing rubber latex solution, and a step (iii) of solidifying and drying the slurry-containing rubber latex solution to produce the rubber wet masterbatch. The cellulose fiber has an average fiber diameter less than 1000 nm. When an amount of solid in the rubber latex solution blended in the step (ii) is regarded as 100 parts by mass, a blend amount of the cellulose fiber is from 0.1 to 50 parts by mass.

### BACKGROUND OF THE INVENTION

### Field of the Invention

The present invention relates to a method for producing a rubber wet masterbatch yielded using, as raw materials, a cellulose fiber, an inorganic filler, a dispersing solvent, and a rubber latex solution.

### Description of the Related Art

It has been hitherto known in the rubber industry that when a rubber composition containing an inorganic filler is produced, a rubber wet masterbatch is used to improve the workability of the composition and the dispersibility of the inorganic filler therein. This is obtained by a manner of mixing an inorganic filler and a dispersing solvent beforehand with each other at a predetermined ratio, dispersing the inorganic filler into the dispersing solvent by a mechanical force, mixing the resultant inorganic-filler-containing slurry solution with a rubber latex solution in a liquid phase, adding a solidifier such as an acid, after the mixing, to the mixture to solidify the mixture, collecting the solidified product, and then drying the collected product. The use of the rubber wet masterbatch can give a rubber composition better in filler-dispersibility, and rubber physical properties such as workability and reinforceability than the use of any rubber dry masterbatch, which is yielded by mixing an inorganic filler and a rubber with each other in a solid phase. The use of such a rubber composition as a raw material makes it possible to produce rubber products, for example, pneumatic tires decreased in rolling resistance and excellent in fatigue resistance and reinforceability.

Apart from the above, there is known a technique of blending the cellulose fiber into a rubber wet masterbatch while paying attention to a reinforcing effect of a cellulose fiber. For example, Patent Document 1 listed below discloses a technique of giving a mechanical shearing force to an aqueous suspension containing a cellulose fiber and an inorganic filler to make the cellulose fiber fibrous, mixing the resultant aqueous suspension with a rubber latex, and then drying the mixed liquid.

### PRIOR ART DOCUMENT

### Patent Document

### Patent Document 1: Japanese Patent No. 6000598

### SUMMARY OF THE INVENTION

However, the present inventor has made eager investigations to make it evident that in the above-mentioned prior art, from the viewpoint of an improvement of an inorganic filler in dispersibility, there remains a room for a further improvement. Specifically, in Patent Document 1, it is an object to make a cellulose fiber fibrous (minute); thus, it has been made evident that there remains a room for a further improvement in the dispersibility of an inorganic filler contained in the finally obtained rubber/cellulose masterbatch.

In the light of the above-mentioned actual situation, the present invention has been accomplished. An object thereof is to provide a method for producing a rubber wet masterbatch in which an inorganic filler is excellent in dispersibility.

The present invention relates to a method for producing a rubber wet masterbatch, including a step (i) of dispersing an inorganic filler into a dispersing solvent in the presence of a cellulose fiber to produce a slurry solution, a step (ii) of mixing the slurry solution and a rubber latex solution with each other to produce a slurry-containing rubber latex solution, and a step (iii) of solidifying and drying the slurry-containing rubber latex solution to produce the rubber wet masterbatch, in which the cellulose fiber has an average fiber diameter of less than 1000 nm, and when an amount of solid in the rubber latex solution blended in the step (ii) is regarded as 100 parts by mass, a blend amount of the cellulose fiber is from 0.1 to 50 parts by mass.

In the rubber wet masterbatch producing method according to the present invention, in the step (i) of dispersing an inorganic filler into a dispersing solvent to produce a slurry solution, in the presence of a cellulose fiber the inorganic filler is dispersed in the dispersing solvent. At this time, as the cellulose fiber, a fiber is used which has an average fiber diameter of less than 1000 nm; thus, this cellulose fiber acts as a dispersing agent so that the inorganic filler is remarkably improved in dispersibility in the slurry solution. Specifically, while an cellulose fiber having an average fiber diameter of less than 1000 nm is taken into aggregated lumps of the inorganic filler in the dispersing solvent, the inorganic filler is dispersed therein. Thus, in this case, the inorganic filler is made remarkably better in dispersibility than in the case of using a cellulose fiber having an average fiber diameter of more than 1000 nm. Moreover, in the rubber wet masterbatch producing method according to the present invention, assuming that the amount of solid in the rubber latex solution as 100 parts by mass, the blend amount of the cellulose fiber is set into the range of 0.1 to 50 parts by mass. In this producing method, improvements are simultaneously made not only in the dispersibility of the inorganic filler but also in the dispersibility of the cellulose fiber. Thus, the finally obtained vulcanized rubber is excellent in rubber physical properties, such as low exothermicity, reinforceability, fatigue resistance, and tear resistance.

It is preferred in the rubber wet masterbatch producing method according to the present invention that the inorganic filler is carbon black since the carbon black is excellent in dispersibility, in particular, in the resultant rubber wet masterbatch.

The present invention also relates to a method for producing a rubber composition for a tire tread, including at least steps of: producing the rubber wet masterbatch by the above-defined rubber wet masterbatch producing method; and dry-mixing a rubber blending agent with the rubber wet masterbatch. A tire tread produced by using, as raw material, a rubber composition, for the tire tread, yielded by this producing method is excellent in the dispersibility of the inorganic filler, in particular, carbon black; and further contains the cellulose fiber, which is similarly excellent in dispersibility, in a predetermined amount. For this reason, in the case of using, as raw material, a rubber composition produced by the producing method according to the present invention, a tire tread can be produced which is excellent in low exothermicity and further in reinforceability and fatigue resistance.

The present invention also relates to a method for producing a rubber composition for a studless tire tread, including at least steps of: producing the rubber wet masterbatch by the above-defined rubber wet masterbatch producing method; and dry-mixing a rubber blending agent with the rubber wet masterbatch. A studless tire tread produced by using, as raw material, a rubber composition, for the studless tire tread, yielded by this producing method is excellent in the dispersibility of the inorganic filler, in particular, carbon black; and further contains the cellulose fiber, which is similarly excellent in dispersibility, in a predetermined amount. For this reason, in the case of using, as raw material, a rubber composition produced by the producing method according to the present invention, a studless tire tread can be produced which is excellent in low exothermicity, and further in ice braking performance owing to the matter that the cellulose fiber produces a scratching effect onto an ice road surface.

The present invention also relates to a method for producing a rubber composition for a tire sidewall, including at least steps of: producing the rubber wet masterbatch by the above-defined rubber wet masterbatch producing method; and dry-mixing a rubber blending agent with the rubber wet masterbatch. A tire sidewall produced by using, as raw material, a rubber composition, for the tire sidewall, yielded by this producing method is excellent in the dispersibility of the inorganic filler, in particular, carbon black; and further contains the cellulose fiber, which is similarly excellent in dispersibility, in a predetermined amount. For this reason, in the case of using, as raw material, a rubber composition produced by the producing method according to the present invention, a tire sidewall can be produced which is excellent in low exothermicity and fatigue resistance, and is further excellent in tear resistance owing to the matter that the cellulose fiber hinders the advance of cracking of the vulcanized rubber.

The present invention also relates to a method for producing a rubber composition for a tire bead filler, including at least steps of: producing the rubber wet masterbatch by the above-defined rubber wet masterbatch producing method; and dry-mixing a rubber blending agent with the rubber wet masterbatch. A tire bead filler produced by using, as raw material, a rubber composition, for the tire bead filler, yielded by this producing method is excellent in the dispersibility of the inorganic filler, in particular, carbon black; and further contains the cellulose fiber, which is similarly excellent in dispersibility, in a predetermined amount. For this reason, in the case of using, as raw material, a rubber composition produced by the producing method according to the present invention, a tire bead filler can be produced which is excellent in low exothermicity and further in fatigue resistance.

### DETAILED DESCRIPTION OF THE PREFERRED EMBODIMENTS

The present invention relates to a method for producing a rubber wet masterbatch using, as raw materials, at least a cellulose fiber, an inorganic filler, a dispersing solvent, and a rubber latex solution.

The cellulose fiber may be prepared by: using, as a raw material, a cellulose fiber prepared from a natural plant fiber that may be of various types, examples of the plant including woods, rice hulls, straws, and bamboos; dispersing this raw material into water; and then applying chemical treatment or mechanical treatment to the dispersion to adjust the average fiber diameter into less than 1000 nm beforehand. The method for applying the chemical treatment to the raw material may be, for example, a method of adding TEMPO (2,2,6,6-tetramethylpiperidine-1-oxyl radicals) as a catalyst to a cellulose fiber dispersed in water, adjusting the resultant into a pH of 10, adding sodium hypochlorite solution in water thereto, stirring the resultant dispersion, filtrating the dispersion, washing the resultant target, and further diluting the resultant with water. The method for the mechanical treatment is, for example, a method of subjecting a cellulose fiber dispersed in water to grinding treatment by a stone mill method.

The average fiber diameter of the cellulose fiber used in the step (i) is less than 1000 nm, preferably less than 100 nm. In the present invention, a cellulose fiber having an average fiber diameter of less than 100 nm is referred to as a cellulose nanofiber. In the step (i), the use of the cellulose nanofiber is particularly preferred. In the present invention, about the “average fiber diameter”, from a scanning electron microscopic image (SEM) of a cellulose fiber, 10 filaments thereof are collected at random, and the respective short diameters thereof are measured. The arithmetical mean thereof is gained, and the resultant mean is defined as the average fiber diameter of the fiber. About the cellulose fiber used in the present invention, the average fiber length thereof is not particularly limited. The length is, for example, from about 0.1 to 100 μm.

The blend amount of the cellulose fiber in the rubber wet masterbatch is preferably set into a predetermined range to improve the inorganic filler, in particular, carbon black in dispersibility in the finally obtained vulcanized rubber, and improve the vulcanized rubber in low exothermicity. Specifically, when the amount of solid in the rubber latex solution is regarded as 100 parts by mass, the blend amount of the cellulose fiber is adjusted into a range preferably from 0.1 to 50 parts by mass, more preferably from 0.5 to 30 parts by mass.

The inorganic filler may be, for example, carbon black or silica. In the present invention, the inorganic filler is preferably carbon black.

In the present invention, the carbon black is any carbon black used in an ordinary rubber industry, such as SAF, ISAF, HAF, FEF, or GPF. The carbon black may be an electroconductive carbon black such as acetylene black or Ketchen black. The carbon black may be any granulated carbon black, which has been granulated, considering the handleability of the carbon black in an ordinary rubber industry; or a non-granulated carbon black. When the total amount of one or more rubber components in a rubber composition yielded using, as a raw material thereof, the rubber wet masterbatch is regarded as 100 parts by mass, the blend amount of the carbon black is preferably from 10 to 100 parts by mass, more preferably from 30 to 80 parts by mass.

The silica may be, for example, wet silica or dry silica. Among these silica species, the use of wet silica, which contains hydrated silicic acid as a main component, is preferred. When the total amount of the rubber component(s) in the rubber composition yielded using, as a raw material thereof, the rubber wet masterbatch is regarded as 100 parts by mass, the blend amount of the silica is preferably from 10 to 100 parts by mass, more preferably from 30 to 80 parts by mass.

The dispersing solvent is in particular preferably water. However, the dispersing solvent may be, for example, water containing an organic solvent.

The rubber latex solution may be any natural rubber latex solution, or synthesized rubber latex solution.

The natural rubber latex solution is a natural product obtained by metabolic effect of a plant. Particularly preferred is a natural-rubber/water based latex solution in which a dispersing solvent is water. About the natural rubber rubber latex, concentrated latex, fresh latex named field latex, and other latexes are usable without being distinguished from each other. The synthetic rubber latex solution is, for example, a rubber latex solution in which styrene-butadiene rubber, butadiene rubber, nitrile rubber or chloroprene rubber has been produced by emulsion polymerization.

The following will describe the method for producing a rubber wet masterbatch according to the present invention. This producing method has a step (i) of dispersing an inorganic filler, in particular, carbon black into a dispersing solvent in the presence of a cellulose fiber to produce a slurry solution, a step (ii) of mixing the slurry solution and a rubber latex solution with each other to produce a slurry-containing rubber latex solution, and a step (iii) of solidifying and drying the slurry-containing rubber latex solution to produce a rubber wet masterbatch. In an embodiment described below, an example using carbon black as the inorganic filler will be described.

### (1) Step (i)

In the step (i), carbon black is dispersed into a dispersing solvent in the presence of a cellulose fiber having an average fiber diameter of less than 1000 nm to produce a slurry solution containing the cellulose fiber and the carbon black. About a timing when the carbon black is added to the dispersing solvent, it is allowable to add the cellulose fiber beforehand to the dispersing solvent to disperse the cellulose fiber in the dispersing solvent as required, and then add the carbon black to this dispersion system; or to add the carbon black beforehand to the dispersing solvent, and then add the cellulose fiber to the dispersion system. Alternatively, the carbon black and the cellulose fiber may be simultaneously added to the dispersing solvent. In the step (i), the concentration of the carbon black in the dispersing solvent may be appropriately adjusted, considering the workability of this step, and other factors. When the dispersibility of the carbon black is considered, the concentration thereof is preferably from about 2 to 15% by mass. In the step (i), similarly, the concentration of the cellulose fiber in the dispersing solvent may be appropriately adjusted, considering the workability, and other factors. When the dispersibility of the cellulose fiber is considered, the concentration thereof is preferably from about 0.1 to 5.0% by mass.

In the step (i), the proportion of the addition amount of the cellulose fiber to that of the carbon black is, for example, from 0.1 to 100% by mass. In order to produce a slurry solution in which the carbon black is evenly dispersed, the proportion of the addition amount of the cellulose fiber to that of the carbon black is preferably set to 60% or less by mass. For reference, if the proportion of the addition amount of the cellulose fiber to that of the carbon black is remarkably small, the breaking of the carbon black is not sufficiently advanced by the cellulose fiber with ease when the carbon black is dispersed into the dispersing solvent. It is therefore preferred that the proportion of the addition amount of the cellulose fiber to that of the carbon black is preferably set to 0.5% or more by mass.

In the step (i), the method for dispersing the carbon black into the dispersing solvent in the presence of the cellulose fiber is, for example, a method for dispersing the carbon black, using an ordinary dispersing machine such as a highly shearing mixer, a homo-mixer, a ball mill, a bead mill, a high-pressure homogenizer, an ultrasonic homogenizer or a colloid mill. In the step (i) in the present invention, it is particularly preferred to disperse the carbon black into the dispersing solvent in the presence of the cellulose fiber, using a highly shearing mixer.

The “highly shearing mixer” means a mixer having a high-speed-rotatable rotor and a fixed stator in which in the state of making a precise clearance between the rotor and the stator, the rotor is rotated so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. An example thereof is a mixer, “High Shear Mixer”, manufactured by a company Silverson.

### (2) Step (ii)

In the step (ii), the slurry solution and a rubber latex solution are mixed with each other to produce a slurry-containing rubber latex solution. The method for mixing the slurry solution with the rubber latex solution in a liquid phase is not particularly limited, and is, for example, a method of mixing, using an ordinary dispersing machine or a mixing machine in which a blade is rotated in a cylindrical vessel, examples of the former machine including a highly shearing mixer, a High Shear Mixer, a homo-mixer, a ball mill, a bead mill, a high-pressure homogenizer, an ultrasonic homogenizer and a colloid mill. At the time of the mixing, the whole of the mixing system, for example, the dispersing machine may be optionally heated.

(3) Step (iii)

In the step (iii), the slurry-containing rubber latex solution is solidified initially to produce a carbon-black-containing rubber solidified product. The method for solidifying is, for example, a method of incorporating a solidifier into the slurry-containing rubber latex solution. In this case, the solidifier may be an acid or salt that is usually used to solidify a rubber latex solution, for example, formic acid, sulfuric acid or sodium chloride. In the step (iii) next, the carbon-black-containing rubber solidified product is dehydrated and dried to produce a rubber wet masterbatch finally. The method for dehydrating and drying the resultant carbon-black-containing rubber solidified product may be a method of using, for example, a uniaxial extruder to give a shearing force to the carbon-black-containing rubber solidified product while heating this product to 100 to 250° C., so as to dehydrate and dry the product. The present rubber wet masterbatch producing method may include, before the dehydration and drying, a solid/liquid-separating step using a centrifugal separator or a vibrating screen in order to decrease, into an appropriate degree, the water amount contained in the carbon-black-containing rubber solidified product. Alternatively, the method may include a washing step, such as a water washing method, in order to wash the solidified product. In order to dry the rubber wet masterbatch further, various drying machines are usable, examples thereof including an oven, a vacuum drier, and an air drier.

After the step (iii), rubber blending agents are dry-mixed with the resultant rubber wet masterbatch to produce a rubber composition that may be of various types. The usable blending agents may be blending agents used ordinarily in the rubber industry. Examples thereof include sulfur-based vulcanizers, vulcanization promoters, antiaging agents, silica, silane coupling agents, zinc oxide, methylene acceptors and methylene donors, stearic acid, vulcanization promotion aids, vulcanization retarders, organic peroxides, softeners such as wax and oil, and working aids.

The species of sulfur in each of the sulfur-based vulcanizers may be any ordinary sulfur species for rubbers. Examples thereof include powdery sulfur, precipitated sulfur, insoluble sulfur, and highly dispersible sulfur. The sulfur content in the tire rubber composition according to the present invention is preferably from 0.5 to 5.0 parts by mass with respect to 100 parts by mass of the rubber component(s).

The vulcanization promoters may each be a vulcanization promoter usable ordinarily for vulcanizing rubbers. Examples thereof include sulfenamide type, thiuram type, thiazole type, thiourea type, guanidine type, and dithiocarbamic acid salt type vulcanization promoters. These may be used singly or in the form of an appropriate mixture. The content of the vulcanization promoter is more preferably from 0.1 to 5.0 parts by mass with respect to 100 parts by mass of the rubber component(s).

The antiaging agents may each be an antiaging agent usable usually for rubbers, examples thereof including aromatic amine type, amine-ketone type, monophenolic type, bisphenolic type, polyphenolic type, dithiocarbamic acid salt type, and thiourea type antiaging agents. These may be used singly or in the form of an appropriate mixture. The content of the antiaging agent(s) is preferably from 0.5 to 10 parts by mass with respect to 100 parts by mass of the rubber component(s).

As described above, the rubber wet masterbatch yielded in the step (iii) is excellent in carbon black dispersibility therein and further contains the cellulose fiber having an average fiber diameter of less than 1000 nm in the predetermined amount. For the reason, the rubber wet masterbatch is useful as a raw material of a rubber composition for tires, in particular a rubber composition for tire treads, a rubber composition for studless tire treads, a rubber composition for tire sidewalls, and a rubber composition for tire bead fillers. Hereinafter, a description will be made about respective methods for producing these rubber compositions.

### (Method for Producing Rubber Composition for Tire Tread)

A rubber composition for a tire tread can be produced by dry-mixing the above-mentioned rubber blending agents with the resultant rubber wet masterbatch after the step (iii). The resultant rubber composition for a tire tread is, for example, extrusion-shaped into a predetermined shape to produce an unvulcanized tire tread member. This member is combined with other tire members, and the combined resultant is finally vulcanized and shaped. In this way, a pneumatic tire can be produced. The pneumatic tire, which has the tire tread yielded by using, as a raw material, the rubber composition for the tire tread, produced by the producing method according to the present invention, is excellent in low exothermicity and also excellent in reinforceability and fatigue resistance, as will be shown in experimental results described later.

### (Method for Producing Rubber Composition for Studless Tire Tread)

A rubber composition for a studless tire tread can be produced by dry-mixing the above-mentioned rubber blending agents with the resultant rubber wet masterbatch after the step (iii). The resultant rubber composition for a studless tire tread is, for example, extrusion-shaped into a predetermined shape to produce an unvulcanized studless tire tread member. This member is combined with other tire members, and the combined resultant is finally vulcanized and shaped. In this way, a pneumatic tire can be produced. The pneumatic tire, which has the studless tire tread yielded by using, as a raw material, the rubber composition for the studless tire tread, produced by the producing method according to the present invention, is excellent in low exothermicity and also excellent in ice braking performance, as will be shown in experimental results described later.

### (Method for Producing Rubber Composition for Tire Sidewall)

A rubber composition for a tire sidewall can be produced by dry-mixing the above-mentioned rubber blending agents with the resultant rubber wet masterbatch after the step (iii). The resultant rubber composition for a tire sidewall is, for example, extrusion-shaped into a predetermined shape to produce an unvulcanized tire sidewall member. This member is combined with other tire members, and the combined resultant is finally vulcanized and shaped. In this way, a pneumatic tire can be produced. The pneumatic tire, which has the tire sidewall yielded by using, as a raw material, the rubber composition for the tire sidewall, produced by the producing method according to the present invention, is excellent in low exothermicity and further excellent in tear resistance and fatigue resistance, as will be shown in experimental results described later.

### (Method for Producing Rubber Composition for Tire Bead Filler)

A rubber composition for a tire bead filler can be produced by dry-mixing the above-mentioned rubber blending agents with the resultant rubber wet masterbatch after the step (iii). The resultant rubber composition for a tire bead filler is, for example, extrusion-shaped into a predetermined shape to produce an unvulcanized tire bead filler member. This member is combined with other tire members, and the combined resultant is finally vulcanized and shaped. In this way, a pneumatic tire can be produced. The pneumatic tire, which has the tire bead filler yielded by using, as a raw material, the rubber composition for the tire bead filler, produced by the producing method according to the present invention, is excellent in low exothermicity and fatigue resistance, as will be shown in experimental results described later.

### EXAMPLES

Hereinafter, this invention will be more specifically described through descriptions about working examples of the invention.

### (Used Raw Materials)

a) Carbon blacks:

Carbon black (N330): “SEAST 3”, manufactured by Tokai Carbon Co., Ltd.),

Carbon black (N339): “SEAST KH”, manufactured by Tokai Carbon Co., Ltd.), and

Carbon black (N550): “SEAST SO”, manufactured by Tokai Carbon Co., Ltd.);

b) Cellulose fiber (powdery cellulose): “KC FLOCK W-400G” (average particle diameter: about 24 μm; manufactured by NIPPON PAPER Chemicals Co., Ltd.);

c) Cellulose nanofibers:

Cellulose nanofiber (1): A nanofiber was used which was produced by adding TEMPO (2,2,6,6-tetramethylpiperidine-1-oxyl radicals) as a catalyst to a cellulose (“KC FLOCK W-400G” (manufactured by NIPPON PAPER Chemicals Co., Ltd.)) dispersed in water, adjusting the resultant into a pH of 10, adding a sodium hypochlorite solution thereto, stirring the resultant liquid, filtrating the solution, washing the resultant target, and further diluting the resultant with water (average fiber diameter=about 3 nm), and

Cellulose nanofiber (2): A nanofiber (“Supermasscolloider MKCA6-2”, (manufactured by Masuko Sangyo Co., Ltd.); (average fiber diameter=10 to 50 nm)) was used, which was produced by mixing a cellulose and water with each other, stirring the mixture, and then grinding the mixture by a stone mill method;

d) Dispersing solvent: Water;

e) Rubber latex solution (natural rubber concentrated latex solution): Product (manufactured by a company Legitex) in which the DRC (dry rubber content) was 60%;

f) Natural rubber: “RSS #3”;

g) Solidifier: Formic acid (solution obtained by diluting a first-class 85% solution thereof into a 10% solution, and adjusting the pH of the diluted solution to 1.2) (manufactured by Nacalai Tesque, Inc.);

h) Zinc oxide: “Zinc Oxide, Type II” (manufactured by Mitsui Mining & Smelting Co., Ltd.);

i) Stearic acid: “RUNACK S-20” (manufactured by Kao Corp.);

j) Wax: “OZOACE 0355” (manufactured by Nippon Seiro Co., Ltd.);

k) Antiaging agents:

Antiaging agent (A): (N-phenyl-N′-(1,3-dimethylbutyl)-p-phenylenediamine, “6C” (manufactured by Ouchi Shinko Chemical Industrial Co., Ltd.), and

Antiaging agent (B): 2,2,4-trimethyl-1,2-dihydroquinoline polymer, “RD” (manufactured by Ouchi Shinko Chemical Industrial Co., Ltd.);

1) Sulfur: (manufactured by Tsurumi Chemical Industry Co., Ltd.);

m) Vulcanization promoters:

Vulcanization promoter (A): N-cyclohexyl-2-benzothiazole sulfenamide: “SUNCELLER CM” (manufactured by Sanshin Chemical Industry Co., Ltd.),

Vulcanization promoter (B): “SOXINOL CZ” (manufactured by Sumitomo Chemical Co., Ltd.), and

Vulcanization promoter (C): “NOCCELER NS-P” (manufactured by Ouchi Shinko Chemical Industrial Co., Ltd.);

n) Polybutadiene rubber: “BR 150B” (manufactured by Ube Industries, Ltd.);

o) Silica: “NIPSIL AQ” (manufactured by Tosoh Corp.); p) Silane coupling agent: “Si 69” (manufactured by Evonik Industries AG);

q) Oils:

Oil (A): “PROCESS P200” (manufactured by Japan Energy Corp.), and

Oil (B): “PROCESS NC140” (manufactured by Japan Energy Corp.); and

r) Phenolic resin: “SUMILITE RESIN PR133491” (manufactured by Sumitomo Bakelite Co., Ltd.).

Method for Producing Rubber Wet Masterbatches, and Rubber Compositions for Tire Treads:

### Examples 1 to 5, and Comparative Example 4

In each of the examples, into water as a dispersing solvent were simultaneously added a cellulose nanofiber and carbon black having respective amounts shown in Table 1. A powder-liquid blending mixer (Flash Blend) manufactured by a company Silverson, which is a highly shearing mixer, was used to disperse these solid components into water (Flash Blend conditions: a rotation number of 3600 rpm and a period of 30 minutes) to produce a slurry solution containing the cellulose nanofiber and the carbon black (step (i)). Into the resultant slurry solution was added natural rubber latex solution having a solid content shown in Table 1, and then a mixer (Super Mixer SM-20) manufactured by Kawata Mfg. Co., Ltd. was used to mix the slurry solution and the latex solution (mixer conditions: a rotation number of 1000 rpm and a period of 30 minutes) to produce a slurry-containing natural rubber latex solution (step (ii)).

To the slurry-containing natural rubber latex solution produced in the step (ii) was added formic acid, as a solidifier, until the pH of the whole of the solution turned to 4. In this way, carbon-black-containing natural rubber solidified product was produced. The resultant carbon-black-containing natural rubber solidified product was subjected to a solid-liquid separating step. Next, the resultant was charged into a screw press, model V-02, manufactured by Suehiro EPM Corp. to dry the solidified product to produce a rubber wet masterbatch (step (iii)). In Table 1, the blend proportion of each of the components is represented by the numerical value of parts by mass (phr) thereof when the total amount of (solid in) the rubber component in the corresponding natural rubber latex solution is regarded as 100 parts by mass.

Into the resultant rubber wet masterbatch were added various rubber blending agents shown in Table 1, and a Banbury mixer was used to dry-mix these components with each other to produce a rubber composition for a tire tread. In Table 1, the blend proportion of each of the components is represented by the numerical value of parts by mass (phr) thereof when the total amount of (solid in) the rubber component in the corresponding natural rubber latex solution is regarded as 100 parts by mass.

### Comparative Examples 1 to 3

In Comparative Example 1, instead of the production of the rubber wet masterbatch, a rubber composition was produced by adding natural rubber (RSS #3), carbon black and various rubber blending agents shown in Table 1, and dry-mixing these components with each other. In Comparative Example 2, a rubber wet masterbatch and a rubber composition were produced in the same way as in Examples 1 to 5 except that in the step (i), no cellulose nanofiber was blended. In Comparative Example 3, a rubber wet masterbatch and a rubber composition were produced in the same way as in Examples 1 to 5 except that in the step (i), instead of the cellulose nanofiber, a cellulose fiber was blended.

### (Evaluations)

A predetermined mold was used to heat and vulcanize each of the rubber compositions at 150° C. for 30 minutes. The resultant rubber was evaluated.

### (Low Exothermicity)

In accordance with JIS K6394, tan δ of the vulcanized rubber was measured at a frequency of 10 Hz, a dynamic strain of 2%, and a temperature of 70° C. About an evaluation thereof, the result value was represented as an index relative to the tan δ value of Comparative Example 1, which was regarded as 100. It is meant that as the numerical value is smaller, the tan δ is smaller (=lower in exothermicity) to be better.

### (Reinforceability)

In accordance with JIS K6251, a tensile test (dumbbell-form No. 3 shape) was made to measure the tensile strength of the vulcanized rubber. About an evaluation thereof, the result value was represented as an index relative to the tensile strength value of Comparative Example 1, which was regarded as 100. It is meant that as the numerical value is larger, the breaking strength is larger to be better.

### (Fatigue Resistance)

In accordance with JIS K6260, the resultant value was represented as an index relative to the evaluation value of the flex cracking resistance of Comparative Example 1, which was regarded as 100. It is meant that as the numerical value is larger, the fatigue resistance is larger to be better.

TABLE 1

| | | | | | | | | |
|---|---|---|---|---|---|---|---|---|
| Comparative | Comparative | Comparative | Comparative | Exam- | Exam- | | | |
| Example 1 | Example 2 | Example 3 | Example 4 | ple 1 | ple 2 | Example 3 | Example 4 | Example 5 |

Blend

| | | | | | | | | | | |
|---|---|---|---|---|---|---|---|---|---|---|
| Rubber wet | Carbon black (N330) | | 50 | 50 | 50 | 50 | 50 | 50 | 50 | 50 |
| masterbatch | Cellulose fiber | | | 10 | | | | | | |
| blending | Cellulose nanofiber (1) | | | | 80 | 1 | | 0.5 | 10 | 30 |
| components | Cellulose nanofiber (2) | | | | | | 1 | | | |
| | Rubber latex solution | | 100 | 100 | 100 | 100 | 100 | 100 | 100 | 100 |
| | (solid content therein) | | | | | | | | | |
| Rubber | Natural rubber | 100 | | | | | | | | |
| composition | Carbon black (N330) | 50 | | | | | | | | |
| blending | Zinc oxide | 3 | 3 | 3 | 3 | 3 | 3 | 3 | 3 | 3 |
| components | Stearic acid | 2 | 2 | 2 | 2 | 2 | 2 | 2 | 2 | 2 |
| | Wax | 1 | 1 | 1 | 1 | 1 | 1 | 1 | 1 | 1 |
| | Antiaging agent (A) | 2 | 2 | 2 | 2 | 2 | 2 | 2 | 2 | 2 |
| | Antiaging agent (B) | 1 | 1 | 1 | 1 | 1 | 1 | 1 | 1 | 1 |
| | Sulfur | 2 | 2 | 2 | 2 | 2 | 2 | 2 | 2 | 2 |
| | Vulcanization | 1 | 1 | 1 | 1 | 1 | 1 | 1 | 1 | 1 |
| | promoter (A) | | | | | | | | | |

Vulcanized rubber physical properties

| | | | | | | | | | |
|---|---|---|---|---|---|---|---|---|---|
| Low exothermicity (index) | 100 | 80 | 95 | 100 | 75 | 78 | 77 | 72 | 73 |
| Reinforceability (index) | 100 | 102 | 107 | 95 | 105 | 106 | 103 | 108 | 108 |
| Fatigue resistance (index) | 100 | 105 | 95 | 90 | 115 | 113 | 110 | 118 | 115 |

Method for Producing Rubber Wet Masterbatches, and Rubber Compositions for Studless Tire Treads:

### Examples 6 to 10, and Comparative Example 8

In each of the examples, into water as a dispersing solvent were simultaneously added a cellulose nanofiber and carbon black having respective amounts shown in Table 2. A powder-liquid blending mixer (Flash Blend) manufactured by a company Silverson, which is a highly shearing mixer, was used to disperse these solid components into water (Flash Blend conditions: a rotation number of 3600 rpm and a period of 30 minutes) to produce a slurry solution containing the cellulose nanofiber and the carbon black (step (i)). Into the resultant slurry solution was added natural rubber latex solution having a solid content shown in Table 2, and then a mixer (Super Mixer SM-20) manufactured by Kawata Mfg. Co., Ltd. was used to mix the slurry solution and the latex solution (mixer conditions: a rotation number of 1000 rpm and a period of 30 minutes) to produce a slurry-containing natural rubber latex solution (step (ii)).

To the slurry-containing natural rubber latex solution produced in the step (ii) was added formic acid, as a solidifier, until the pH of the whole of the solution turned to 4. In this way, carbon-black-containing natural rubber solidified product was produced. The resultant carbon-black-containing natural rubber solidified product was subjected to a solid-liquid separating step. Next, the resultant was charged into a screw press, model V-02, manufactured by Suehiro EPM Corp. to dry the solidified product to produce a rubber wet masterbatch (step (iii)). In Table 2, the blend proportion of each of the components is represented by the numerical value of parts by mass (phr) thereof when the total amount of (solid in) the rubber component in the corresponding natural rubber latex solution is regarded as 100 parts by mass.

Into the resultant rubber wet masterbatch were added various rubber blending agents shown in Table 2, and a Banbury mixer was used to dry-mix these components with each other to produce a rubber composition for a tire tread. In Table 2, the blend proportion of each of the components is represented by the numerical value of parts by mass (phr) thereof when the total amount of (solid in) the rubber component in the corresponding natural rubber latex solution is regarded as 100 parts by mass.

### Comparative Examples 5 to 7

In Comparative Example 5, instead of the production of the rubber wet masterbatch, a rubber composition was produced by adding natural rubber (RSS #3), polybutadiene rubber, carbon black and various rubber blending agents shown in Table 2, and dry-mixing these components with each other. In Comparative Example 6, a rubber wet masterbatch and a rubber composition were produced in the same way as in Examples 6 to 10 except that in the step (i), no cellulose nanofiber was blended. In Comparative Example 7, a rubber wet masterbatch and a rubber composition were produced in the same way as in Examples 6 to 10 except that in the step (i), instead of the cellulose nanofiber, a cellulose fiber was blended.

### (Evaluations)

A predetermined mold was used to heat and vulcanize each of the rubber compositions at 150° C. for 30 minutes. The resultant rubber was evaluated.

### (Ice Braking Performance)

On an icy road having temperature of −3±3° C., an ABS operation was applied to a 2000-cc 4-WD car with tires having the rubber and running at 40 km/hour to measure the braking distance thereof (the average of values obtained according to n=10). About an evaluation thereof, the result value is represented as an index relative to the inverse number of the braking distance of Comparative Example 1, the inverse number being regarded as 100. It is meant that as the numerical value is larger, the braking distance is shorter to be better.

TABLE 2

| Comparative | Comparative | Comparative | Comparative | | Exam- | Exam- | Exam- | Example |
|---|---|---|---|---|---|---|---|---|
| Example 5 | Example 6 | Example 7 | Example 8 | Example 6 | ple 7 | ple 8 | ple 9 | 10 |

Blend

| | | | | | | | | | | |
|---|---|---|---|---|---|---|---|---|---|---|
| Rubber wet | Carbon black (N339) | | 50 | 50 | 50 | 50 | 50 | 50 | 50 | 50 |
| masterbatch | Cellulose fiber | | | 10 | | | | | | |
| blending | Cellulose nanofiber (1) | | | | 80 | 5 | | 1 | 10 | 30 |
| components | Cellulose nanofiber (2) | | | | | | 5 | | | |
| | Rubber latex solution | | 100 | 100 | 100 | 100 | 100 | 100 | 100 | 100 |
| | (solid content therein) | | | | | | | | | |
| Rubber | Natural rubber | 60 | | | | | | | | |
| composition | Rubber wet masterbatch | | | | | | | | | |
| blending | (Natural rubber content) | | (60) | (60) | (60) | (60) | (60) | (60) | (60) | (60) |
| components | (Cellulose content) | | | (6) | (48) | (3) | (3) | (0.6) | (6) | (18) |
| | (Carbon black content) | | (30) | (30) | (30) | (30) | (30) | (30) | (30) | (30) |
| | Polybutadiene rubber | 40 | 40 | 40 | 40 | 40 | 40 | 40 | 40 | 40 |
| | Carbon black (N339) | 40 | 10 | 10 | 10 | 10 | 10 | 10 | 10 | 10 |
| | Silica | 10 | 10 | 10 | 10 | 10 | 10 | 10 | 10 | 10 |
| | Silane coupling agent | 1 | 1 | 1 | 1 | 1 | 1 | 1 | 1 | 1 |
| | Oil (A) | 20 | 20 | 20 | 20 | 20 | 20 | 20 | 20 | 20 |
| | Zinc oxide | 2 | 2 | 2 | 2 | 2 | 2 | 2 | 2 | 2 |
| | Stearic acid | 2 | 2 | 2 | 2 | 2 | 2 | 2 | 2 | 2 |
| | Wax | 2 | 2 | 2 | 2 | 2 | 2 | 2 | 2 | 2 |
| | Antiaging agent (A) | 2 | 2 | 2 | 2 | 2 | 2 | 2 | 2 | 2 |
| | Sulfur | 2 | 2 | 2 | 2 | 2 | 2 | 2 | 2 | 2 |
| | Vulcanization | 1.5 | 1.5 | 1.5 | 1.5 | 1.5 | 1.5 | 1.5 | 1.5 | 1.5 |
| | promoter (B) | | | | | | | | | |

Vulcanized rubber physical properties

| | | | | | | | | | |
|---|---|---|---|---|---|---|---|---|---|
| Low exothermicity (index) | 100 | 85 | 100 | 105 | 80 | 83 | 82 | 77 | 78 |
| Ice braking performance (index) | 100 | 110 | 118 | 130 | 116 | 116 | 113 | 118 | 122 |

Method for Producing Rubber Wet Masterbatches, and Rubber Composition for Tire Sidewalls:

### Examples 11 to 15, and Comparative Examples 12

In each of the examples, into water as a dispersing solvent were simultaneously added a cellulose nanofiber and carbon black having respective amounts shown in Table 3. A powder-liquid blending mixer (Flash Blend) manufactured by a company Silverson, which is a highly shearing mixer, was used to disperse these solid components into water (Flash Blend conditions: a rotation number of 3600 rpm and a period of 30 minutes) to produce a slurry solution containing the cellulose nanofiber and the carbon black (step (i)). Into the resultant slurry solution was added natural rubber latex solution having a solid content shown in Table 3, and then a mixer (Super Mixer SM-20) manufactured by Kawata Mfg. Co., Ltd. was used to mix the slurry solution and the latex solution (mixer conditions: a rotation number of 1000 rpm and a period of 30 minutes) to produce a slurry-containing natural rubber latex solution (step (ii)).

To the slurry-containing natural rubber latex solution produced in the step (ii) was added formic acid, as a solidifier, until the pH of the whole of the solution turned to 4. In this way, carbon-black-containing natural rubber solidified product was produced. The resultant carbon-black-containing natural rubber solidified product was subjected to a solid-liquid separating step. Next, the resultant was charged into a screw press, model V-02, manufactured by Suehiro EPM Corp. to dry the solidified product to produce a rubber wet masterbatch (step (iii)). In Table 3, the blend proportion of each of the components is represented by the numerical value of parts by mass (phr) thereof when the total amount of (solid in) the rubber component in the corresponding natural rubber latex solution is regarded as 100 parts by mass.

Into the resultant rubber wet masterbatch were added various rubber blending agents shown in Table 3, and a Banbury mixer was used to dry-mix these components with each other to produce a rubber composition for tire sidewalls. In Table 3, the blend proportion of each of the components is represented by the numerical value of parts by mass (phr) thereof when the total amount of (solid in) the rubber component in the corresponding natural rubber latex solution is regarded as 100 parts by mass.

### Comparative Examples 9 to 11

In Comparative Example 9, instead of the production of the rubber wet masterbatch, a rubber composition was produced by adding natural rubber (RSS #3), carbon black and various rubber blending agents shown in Table 3, and dry-mixing these components with each other. In Comparative Example 10, a rubber wet masterbatch and a rubber composition were produced in the same way as in Examples 11 to 15 except that in the step (i), no cellulose nanofiber was blended. In Comparative Example 11, a rubber wet masterbatch and a rubber composition were produced in the same way as in Examples 11 to 15 except that in the step (i), instead of the cellulose nanofiber, a cellulose fiber was blended.

### (Evaluations)

A predetermined mold was used to heat and vulcanize each of the rubber compositions at 150° C. for 30 minutes. The resultant rubber was evaluated.

### (Tear Resistance)

In accordance with JIS K6252, the resultant value was represented as an index relative to the value of the tear strength of Comparative Example 1, which was regarded as 100. It is meant that as the numerical value is larger, the tear strength is larger to be better.

TABLE 3

| | | | | | | Exam- | Exam- | Exam- |
|---|---|---|---|---|---|---|---|---|
| Comparative | Comparative | Comparative | Comparative | Example | Example | ple | ple | ple |
| Example 9 | Example 10 | Example 11 | Example 12 | 11 | 12 | 13 | 14 | 15 |

Blend

| | | | | | | | | | | |
|---|---|---|---|---|---|---|---|---|---|---|
| Rubber wet | Carbon black (N550) | | 50 | 50 | 50 | 50 | 50 | 50 | 50 | 50 |
| masterbatch | Cellulose fiber | | | 10 | | | | | | |
| blending | Cellulose nanofiber (1) | | | | 80 | 5 | | 1 | 10 | 30 |
| components | Cellulose nanofiber (2) | | | | | | 5 | | | |
| | Rubber latex solution | | 100 | 100 | 100 | 100 | 100 | 100 | 100 | 100 |
| | (solid content therein) | | | | | | | | | |
| Blending | Natural rubber | 40 | | | | | | | | |
| components | Rubber wet masterbatch | | 60 | 64 | 92 | 62 | 62 | 60.4 | 64 | 72 |
| at rubber | (Natural rubber content) | | (40) | (40) | (40) | (40) | (40) | (40) | (40) | (40) |
| composition | (Cellulose content) | | | (4) | (32) | (2) | (2) | (0.4) | (4) | (12) |
| production | (Carbon black content) | | (20) | (20) | (20) | (20) | (20) | (20) | (20) | (20) |
| time | Polybutadiene rubber | 60 | 60 | 60 | 60 | 60 | 60 | 60 | 60 | 60 |
| | Carbon black (N550) | 50 | 30 | 30 | 30 | 30 | 30 | 30 | 30 | 30 |
| | Oil (B) | 10 | 10 | 10 | 10 | 10 | 10 | 10 | 10 | 10 |
| | Zinc oxide | 3.0 | 3.0 | 3.0 | 3.0 | 3.0 | 3.0 | 3.0 | 3.0 | 3.0 |
| | Stearic acid | 2.0 | 2.0 | 2.0 | 2.0 | 2.0 | 2.0 | 2.0 | 2.0 | 2.0 |
| | Wax | 2.0 | 2.0 | 2.0 | 2.0 | 2.0 | 2.0 | 2.0 | 2.0 | 2.0 |
| | Antiaging agent (A) | 2.0 | 2.0 | 2.0 | 2.0 | 2.0 | 2.0 | 2.0 | 2.0 | 2.0 |
| | Sulfur | 2.0 | 2.0 | 2.0 | 2.0 | 2.0 | 2.0 | 2.0 | 2.0 | 2.0 |
| | Vulcanization | 1.0 | 1.0 | 1.0 | 1.0 | 1.0 | 1.0 | 1.0 | 1.0 | 1.0 |
| | promoter (B) | | | | | | | | | |

Vulcanized rubber physical properties

| | | | | | | | | | |
|---|---|---|---|---|---|---|---|---|---|
| Low exothermicity (index) | 100 | 92 | 95 | 97 | 88 | 89 | 90 | 86 | 87 |
| Tear resistance (index) | 100 | 90 | 88 | 82 | 101 | 100 | 100 | 103 | 102 |
| Fatigue resistance (index) | 100 | 102 | 98 | 95 | 110 | 108 | 106 | 113 | 111 |

Method for Producing Rubber Wet Masterbatches, and Rubber Compositions for Tire Bead Fillers:

### Examples 16 to 20, and Comparative Example 16

In each of the examples, into water as a dispersing solvent were simultaneously added a cellulose nanofiber and carbon black having respective amounts shown in Table 4. A powder-liquid blending mixer (Flash Blend) manufactured by a company Silverson, which is a highly shearing mixer, was used to disperse these solid components into water (Flash Blend conditions: a rotation number of 3600 rpm and a period of 30 minutes) to produce a slurry solution containing the cellulose nanofiber and the carbon black (step (i)). Into the resultant slurry solution was added natural rubber latex solution having a solid content shown in Table 4, and then a mixer (Super Mixer SM-20) manufactured by Kawata Mfg. Co., Ltd. was used to mix the slurry solution and the latex solution (mixer conditions: a rotation number of 1000 rpm and a period of 30 minutes) to produce a slurry-containing natural rubber latex solution (step (ii)).

To the slurry-containing natural rubber latex solution produced in the step (ii) was added formic acid, as a solidifier, until the pH of the whole of the solution turned to 4. In this way, carbon-black-containing natural rubber solidified product was produced. The resultant carbon-black-containing natural rubber solidified product was subjected to a solid-liquid separating step. Next, the resultant was charged into a screw press, model V-02, manufactured by Suehiro EPM Corp. to dry the solidified product to produce a rubber wet masterbatch (step (iii)). In Table 4, the blend proportion of each of the components is represented by the numerical value of parts by mass (phr) thereof when the total amount of (solid in) the rubber component in the corresponding natural rubber latex solution is regarded as 100 parts by mass.

Into the resultant rubber wet masterbatch were added various rubber blending agents shown in Table 4, and a Banbury mixer was used to dry-mix these components with each other to produce a rubber composition for tire bead fillers. In Table 4, the blend proportion of each of the components is represented by the numerical value of parts by mass (phr) thereof when the total amount of (solid in) the rubber component in the corresponding natural rubber latex solution is regarded as 100 parts by mass.

### Comparative Examples 13 to 15

In Comparative Example 13, instead of the production of the rubber wet masterbatch, a rubber composition was produced by adding natural rubber (RSS #3), carbon black and various rubber blending agents shown in Table 4, and dry-mixing these components with each other. In Comparative Example 14, a rubber wet masterbatch and a rubber composition were produced in the same way as in Examples 16 to 20 except that in the step (i), no cellulose nanofiber was blended. In Comparative Example 15, a rubber wet masterbatch and a rubber composition were produced in the same way as in Examples 16 to 20 except that in the step (i), instead of the cellulose nanofiber, a cellulose fiber was blended.

### (Evaluations)

A predetermined mold was used to heat and vulcanize each of the rubber compositions at 150° C. for 30 minutes. The resultant rubber was evaluated.

### (Rubber Hardness)

In accordance with JIS K7215, the resultant value was represented as an index relative to the value of the rubber hardness of Comparative Example 1, which was regarded as 100. It is meant that as the numerical value is larger, the rubber hardness is higher to be better.

TABLE 4

| Comparative | Comparative | Comparative | Comparative | Example | Example | Example | Exam- | Exam- |
|---|---|---|---|---|---|---|---|---|
| Example 13 | Example 14 | Example 15 | Example 16 | 16 | 17 | 18 | ple 19 | ple 20 |

Blend

| | | | | | | | | | | |
|---|---|---|---|---|---|---|---|---|---|---|
| Rubber wet | Carbon black (N550) | | 80 | 80 | 80 | 80 | 80 | 80 | 80 | 80 |
| masterbatch | Cellulose fiber | | | 10 | | | | | | |
| blending | Cellulose nanofiber (1) | | | | 80 | 1 | | 0.5 | 10 | 30 |
| components | Cellulose nanofiber (2) | | | | | | 1 | | | |
| | Rubber latex solution | | 100 | 100 | 100 | 100 | 100 | 100 | 100 | 100 |
| | (solid content therein) | | | | | | | | | |
| Blending | Natural rubber | 100 | | | | | | | | |
| components | Carbon black (N550) | 80 | | | | | | | | |
| at rubber | Oil (B) | 6 | 6 | 6 | 6 | 6 | 6 | 6 | 6 | 6 |
| composition | Zinc oxide | 3.0 | 3.0 | 3.0 | 3.0 | 3.0 | 3.0 | 3.0 | 3.0 | 3.0 |
| production | Stearic acid | 2.0 | 2.0 | 2.0 | 2.0 | 2.0 | 2.0 | 2.0 | 2.0 | 2.0 |
| time | Antiaging agent (A) | 1.0 | 1.0 | 1.0 | 1.0 | 1.0 | 1.0 | 1.0 | 1.0 | 1.0 |
| | Phenolic resin | 20 | 20.0 | 20.0 | 20.0 | 20.0 | 20.0 | 20.0 | 20.0 | 20.0 |
| | Sulfur | 3.0 | 3.0 | 3.0 | 3.0 | 3.0 | 3.0 | 3.0 | 3.0 | 3.0 |
| | Vulcanization | 1.0 | 1.0 | 1.0 | 1.0 | 1.0 | 1.0 | 1.0 | 1.0 | 1.0 |
| | promoter (C) | | | | | | | | | |

Vulcanized rubber physical properties

| | | | | | | | | | |
|---|---|---|---|---|---|---|---|---|---|
| Hardness (index) | 100 | 96 | 102 | 108 | 99 | 99 | 98 | 101 | 102 |
| Low exothermicity (index) | 100 | 80 | 95 | 100 | 75 | 78 | 77 | 72 | 73 |
| Fatigue resistance (index) | 100 | 105 | 95 | 90 | 115 | 113 | 110 | 118 | 115 |

What is claimed is:

1. A method for producing a rubber wet masterbatch, comprising a step (i) of dispersing an inorganic filler into a dispersing solvent in the presence of a cellulose fiber to produce a slurry solution, a step (ii) of mixing the slurry solution and a rubber latex solution with each other to produce a slurry-containing rubber latex solution, and a step (iii) of solidifying and drying the slurry-containing rubber latex solution to produce the rubber wet masterbatch,
wherein the cellulose fiber has an average fiber diameter less than 1000 nm, and
when an amount of solid in the rubber latex solution blended in the step (ii) is regarded as 100 parts by mass, a blend amount of the cellulose fiber is from 0.1 to 50 parts by mass.

2. The method for producing a rubber wet masterbatch according to claim 1, wherein the inorganic filler is carbon black.

3. The method for producing a rubber wet masterbatch according to claim 1, wherein the cellulose fiber is a cellulose nanofiber having an average fiber diameter less than 100 nm.

4. The method for producing a rubber wet masterbatch according to claim 1, wherein in the step (i), a proportion of an addition amount of the cellulose fiber to an addition amount of the carbon black is 0.5% or more by mass.

5. A method for producing a rubber composition for a tire tread,
comprising at least steps of: producing the rubber wet masterbatch by the producing method recited in claim 1; and dry-mixing a rubber blending agent with the rubber wet masterbatch.

6. A method for producing a rubber composition for a studless tire tread,
comprising at least steps of: producing the rubber wet masterbatch by the producing method recited in claim 1; and dry-mixing a rubber blending agent with the rubber wet masterbatch.

7. A method for producing a rubber composition for a tire sidewall,
comprising at least steps of: producing the rubber wet masterbatch by the producing method recited in claim 1; and dry-mixing a rubber blending agent with the rubber wet masterbatch.

8. A method for producing a rubber composition for a tire bead filler,
comprising at least steps of: producing the rubber wet masterbatch by the producing method recited in claim 1; and dry-mixing a rubber blending agent with the rubber wet masterbatch.
